(19) United States
(12) Patent Application Publication
(10) Pub. No.: US 2025/0129304 A1
(43) Pub. Date: Apr. 24, 2025

(54) OXY-STEAM BIOMASS GASIFICATON SYSTEM FOR GENERATING HYDROGEN RICH SYNGAS

(71) Applicant: Indian Institute of Science, Karnataka (IN)

(72) Inventors: Srinivasaiah Dasappa, Bangalore (IN); Anand Malhar Shivapuji, Bangalore (IN); Arvind Gupta, Bangalore (IN)

(73) Assignee: Indian Institute of Science, Bangalore (IN)

(21) Appl. No.: 18/685,509

(22) PCT Filed: Sep. 6, 2022
(86) PCT No.: PCT/IN2022/050793

§ 371 Date: Feb. 22, 2024

(30) Foreign Application Priority Data
Jun. 28, 2022 (IN) 202241037110

(51) Int. Cl. C10J 3/26; C10J 3/72

(52) U.S. Cl. CPC C10J 3/26; C10J 3/723; C10J 2200/152; C10J 2300/092; C10J 2300/093; C10J 2300/0959; C10J 2300/0976; C10J 2300/1838

(57) ABSTRACT

Examples of a system (100, 200) and a method (300) for converting a biomass feedstock into a hydrogen rich syngas, are described. The system (100, 200) includes a gasification reactor (102) including an inlet (104) with a lock hopper, an outlet (106), and side walls (108) between the inlet (104) and the outlet (106). The system (100) may further include a plurality of injectors (110, 202) protruding inside the gasification reactor (102) up to a certain depth along the length of the gasification reactor (102). In another example, the plurality of injectors (110, 202) may also be inclined at an angle with respect to the side walls (108) of the gasification reactor (102). The system (100, 200) further comprises a plurality of thermocouples (112) for determining a temperature profile of the gasification reactor (102.

### BACKGROUND

Biomass gasification is a process that converts an organic carbonaceous matter like woody biomass, agricultural residues, and municipal solid waste into combustible gaseous mixture containing Hydrogen, Carbon Monoxide, Methane, Carbon Dioxide and Nitrogen, by reacting the biomass feedstock with controlled amount of oxygen and steam in various proportions and over a range of temperatures. Hydrogen rich syngas is the key product of such a gasification process that may be further processed to generate pure Hydrogen of desired quality and gaseous mixture of desired composition for subsequent downstream use. The Hydrogen so generated may be used in a variety of applications like Fuel Cells (both PEM and SOFC), Internal Combustion Engines, Gas Turbines etc. At the same time, the desired composition-syngas mixture may be used for downstream chemical synthesis through catalytic reforming and use in energy conversion devices like Fuel Cells (SOFC), Internal Combustion Engines, Gas Turbines etc. With Hydrogen being the key compound in the downstream gas, configuration and operational efforts aim to enhance the throughput gas Hydrogen content. The essential design and operational controls are to maximize the generation rate of Char in the reactor and then enhance utilization of Char generated in the gasifier to mitigate the “Carbon Boundary”. Beyond the carbon boundary, the system operation ceases in time.

### BRIEF DESCRIPTION OF FIGURES

The detailed description is presented with reference to the accompanying figures. In the figures, the left-most digit(s) of a reference number identifies the figure in which the reference number first appears. The same numbers are used throughout the drawings to reference like features and components.

FIG. 1 illustrates schematic of a biomass gasification system, in accordance with an implementation of the present subject matter;

FIG. 2 illustrates schematic of another biomass gasification system, in accordance with another implementation of the present subject matter;

FIG. 3 illustrates a process for converting a biomass feedstock into a hydrogen-rich syngas using a biomass gasification system, in accordance with an implementation of the present subject matter;

FIG. 4 is a graph depicting variation in hydrogen generation rate with changing bed temperature, in accordance with an implementation of the present subject matter;

FIG. 5 is a graph depicting variation in the rate of consumption/generation of dry gases with changing bed temperature, in accordance with an implementation of the present subject matter;

FIG. 6 is a graph depicted variation in hydrogen generation rate with changing bed temperature, in accordance with an implementation of the present subject matter;

FIG. 7 is a graph depicting variation in composition of dry gas with changes in steam concentration, in accordance with an implementation of the present subject matter;

FIG. 8 is a graph depicting variation in char consumption with changes in steam concentration, in accordance with an implementation of the present subject matter;

FIG. 9 is a graph depicting variation in the composition of dry gases with changes in steam concentration inside the biomass gasification system, in accordance with an implementation of the present subject matter;

FIG. 10-13 presents graphs depicting variation in temperature in the vicinity of the char zone with time, in accordance with an implementation of the present subject matter;

FIG. 14 is a graph depicting variation in the volume percentage of dry gases in response to change in steam concentration (increasing SBR) for different biomasses as a feedstock, in accordance with an implementation of the present subject matter;

FIG. 15 depicts flow simulation of injecting mixture for a configuration of injectors along the gasification reactor of the biomass gasification system, in accordance with an implementation of the present subject matter; and

FIG. 16 depicts flow simulation of injecting mixture for another configuration of injectors along the gasification reactor of the biomass gasification system, in accordance with an implementation of the present subject matter.

### DETAILED DESCRIPTION

In recent years, rapid technological advancements have led to an unprecedented increase in energy requirement, as a result of which more and more energy sources are being developed or researched to fulfil the requirement. Further, emission of CO₂ has induced climate change affecting every aspect of life on an unprecedented scale which raises a need to emphasis on “green” energy resources. One of such green energy source is combustible gaseous products produced by gasification of carbonaceous matter like woody biomass, agro-residue and municipal solid waste.

As would be generally understood, gasification is a process by which either a solid or liquid carbonaceous material, containing chemically bound carbon, hydrogen, oxygen, and a variety of inorganic and organic constituents, is reacted with either air or mixture of oxygen and steam to provide sufficient exothermic energy to produce a primary gaseous product containing mostly H2, CO, CH4, CO2, N2, H2O(g) and volatile and condensable organic and inorganic compounds. In one example, the material used during gasification may be a biomass substance, which in most of the cases like agro residue, packing wood waste, saw dust etc considered as waste, containing 5-30% moisture. Examples of biomass substance include, but may not be limited to, forest slash, urban wood waste, lumber waste, wood chips, sawdust, straw, firewood, agricultural residue, and the like. Specifically, in biomass gasification, biomass is gasified in presence of steam and/or oxygen to produce “synthesis gas”, rich in CO and H₂, which in turn may be, by appropriate separation process and subsequent catalytic process, converted to high-value fuels and chemicals.

As may be understood, the system converting carbonaceous matter into combustible gas is known as a gasifier or a gasification system, such as an open top downdraft gasifier system with air as gasifying media, a reburn gasifier system with multiple reactant entry points, etc. For brevity, we here only discuss characteristics of the reburn gasifier system with multiple reactant entry points operated in either open top or closed top, as the case may be, which includes a cylindrical reactor receiving biomass form the top and discharging gas from the base and also include multiple nozzles along the length of the reactor for introducing different reactant mixtures, which acts as the gasification media. In an example, the cylindrical reactor may be virtually divided in several zones based on the reactions taking place in that zone such as a drying zone, a pyrolysis zone, a combustion zone and a reduction zone. During gasification, the reactor is initially loaded with charcoal from the bottom up to the level above the combustion zone and topped up with biomass feedstock.

Thereafter, the char bed in the vicinity of side nozzles is ignited through external source, which subsequently starts thermochemical reactions inside the reactor leading to self-sustaining operation as auto thermal mode of operation. Once the char bed is ignited, initially, the fresh biomass at the top is dried up due to the heat generated and the heat transfer through radiation and convection from the hot char bed resulted in formation of the drying zone. Then, the dried biomass is subjected to high-temperature condition which results in pyrolysis of biomass feedstock to convert biomass in gaseous products comprising of CHO complex and carbon as char. Based on the oxidizer/reactants availability inside the reactor, the gaseous products also undergo combustion resulting in heat release rendering the system auto thermal.

Thereafter, the products of pyrolysis, i.e., higher hydrocarbons, gaseous mixture and char, pass through the a zone where volatile react with the oxidiser identified as combustion zone where combustion of a portion of the hydrocarbons/gases/char takes place resulting in high temperature, around 1200° C. in the reactor. Under the conditions of such high temperature, the higher hydrocarbons have a tendency to breakdown to low molecular weight hydrocarbons resulting in relatively clean gas being generated. Thereafter, the gases and solid char move downwards where reaction of char with H2O and CO₂ indentified as reduction zone, takes place. Finally, the products of gasification exit from the base and a known quantify of char is positively extracted through an appropriate mechanism.

The typical thermochemical reactions taking place along the length of the reactor of the gasification system are presented in below Table 1. It may be noted from below table that, the carbon reaction with steam (R2) and Carbon Monoxide reaction with Steam (R9) are the principal hydrogen generating reactions.

TABLE 1
Typical reactions in gasification process

| | | Enthalpy of reaction, |
|---|---|---|
| Reaction type | | kJ/mol |
| Carbon reactions | | |
| Boudouard (R1) | C + CO₂ ↔ 2CO | +172 |
| Water gas (R2) | C + H₂O ↔ CO + H₂ | +131 |
| Hydrogasification (R3) | C + 2H₂ ↔ CH₄ | −74.8 |
| Partial oxidation (R4) | C + ½O₂ → CO | −111 |
| Oxidation reaction | | |
| R5 | C + O₂→ CO₂ | −394 |
| R6 | CO + ½O₂ → CO₂ | −284 |
| R7 | CH₄ + 2O₂ ↔ CO₂ + 2H₂O | −803 |
| R8 | H₂ + ½O₂ → H₂O | −242 |
| Shift reaction reactions | | |
| R9 | CO + H₂O ↔ CO₂ + H₂ | −41.2 |
| Methanation reactions | | |
| R10 | 2CO + 2H₂ → CO₂ + CH₄ | −247 |
| R11 | CO + 3H₂ ↔ CH₄ + H₂O | −206 |
| R12 | CO₂ + 4H₂ → CH₄ + 2H₂O | −165 |
| Methane reforming/partial oxidation reactions | | |
| R13 | CH₄ + H₂O ↔ CO + 3H₂ | +206 |
| R14 | CH₄ + ½O₂ → CO + 2H₂ | −36 |

It is important to note that, the gasification system is operated over a range of operating condition, in which the variations primarily being with steam to biomass ratio (SBR). Other parameters include the equivalence ratio (fuel/oxidiser to stochiometric) and the Oxygen-steam mixture injection temperature. As may be understood from hydrogen generation reaction, i.e., R2 and R9 that, the main element required in an adequate amount for higher hydrogen yield is steam concentration (i.e. H₂O concentration) and the char (i.e. Carbon concentration) generated due to pyrolysis and combustion. In an example, with higher steam concentration, one mole extra hydrogen is generated from steam itself which further leads to reducing consumption of biomass as well. So, for increasing the hydrogen generation capacity of the gasification system, SBR needs to be high.

However, as the SBR increases, the char consumption increases, i.e., generated char is consumed at a higher rate, due to which the sustained operation of the gasification system is sacrificed. It may be noted that for sustained operation a of gasification system to produce hydrogen-rich syngas, the gasification system needs to be operated inside an important parameter called—a Carbon Boundary Limit (CBL). The CBL represents the point at which the rate of char generation is equal to the rate of char consumption. The CBL is a strong function of Steam to Biomass (typically on mole ratio basis) for a given equivalance ratio of oxidiser concentration. As the CBL increases, the Char consumption rate due to Char-Steam reaction increases and if the Char consumption rate increases beyond the generation rate, over time the char produced gets consumed resulting in a ceasing of the gasifier operation to produce combustible gases.

So, for extending CBL beyond its conventional limit, the char generation rate needs to be higher. As may be understood, the char generation solely depends on the rate of pyrolysis which in turn further depends on the temperature profile inside the reactor. Higher the temperature, faster will be the pyrolysis and hence the higher the char generation rate. Such required heat is provided by the energy released by the combustion of volatile species/gases and carbon/char inside the reactor. The temperature of Oxygen-Steam mixture also play a critical role in establishing the temperature profile inside. The higher the mixture temperature, better will be pyrolysis and hence lower will be the endothermicity (heat requirement) for pyrolysis and related reactions to occur inside the reactor, thus improved the temperature profile. Thus supplying the Oxygen-Steam mixture at a higher temperature aids in the pyrolytic process.

Further, the injected oxy-steam mixture needs to be staged and distributed across the reactor and along the length of the reactor, with controlled temperature and equivalence ratio to increase the rate of combustion and hence heat release which in turn increases the temperature inside the reactor and as a commensurate effect the rate of char generation. The oxy-steam gasification key operating conditions of the conventional systems are presented in below Table 2.

TABLE 2
Oxy-steam gasification key operating conditions

| | | Lower | Higher |
|---|---|---|---|
| Sr. No | Parameter | limit | limit |
| 01 | Steam to biomass ratio (mole/mole) | 0.75 | 2.70 |
| 02 | Steam to biomass ratio (kg/kg) | 0.59 | 2.11 |
| 03 | Equivalence ratio | 0.18 | 0.3 |

| | | |
|---|---|---|
| 04 | Oxy-steam mixture injection temperature | 377° C./650 K |
| 05 | Carbon boundary SBR limit (mole/mole) | 1.50 |
| 06 | Carbon boundary SBR limit (kg/kg) | 1.17 |

However, the conventional methodologies, for example conventional system as described in Indian Patent Application 6783/CHE/2015 (or Indian Patent No. 390746) and techniques designed for gasification include injection points of steam/oxygen/mixture along the length of the reactor in a particular line, with the injection being flush with the reactor (closer to the wall inside the reactor). Due to this configuration, the oxy-steam mixture may not penetrate inside the reactor up to its axial axis and remains restricted to one particular zone along the length of the reactor. While the configuration may suffice for small diameter reactors (with inside diameter less than 100 mm), as the diameter increases (as in case of practical reactors ranging from few kWe level and higher), only a small sector along the length of the reactor receives the reactant mixture. This basically results in incomplete reaction of Char with the section diametrically opposite to the injection points having extremely limited accessibility to the reactants (Oxygen-steam mixture). As such even when steam in excess of CB limit is sent, complete Carbon conversion will not take place and the hot gas exiting the reactor will have substantially high moisture content. Basically the Hydrogen yield and system efficiency suffers. Further, there is no disclosure present in conventional gasification system, to appropriately managing the temperature and ratio of the oxy-steam mixture to increase the char generation rate inside the reactor. In the conventional system, the same quality mixture (in terms of temperature and Steam-Oxygen ratio) is injected into the reactor through all the ports. This restricts the ability to control the Char generation rate, especially when the biomass quality and type changes.

Examples of a biomass gasification system and method for producing hydrogen rich syngas from biomass, are described. The proposed biomass gasification system provides higher hydrogen yield for variety of biomasses by controlling and modifying the conventional ways of injection of oxy-steam mixture inside the gasification system. The biomass gasification system comprised of a gasification reactor. The gasification reactor further comprises an inlet, an outlet, and side walls disposed between the inlet and the outlet. In an example, the inlet is a lock-hopper based inlet positioned at the top of the gasification reactor isolating the gasification reactor from ambient air surrounding while charging gasification reactor. The outlet is positioned at the bottom end of the reactor for discharging products of gasification. In an example, the outlet is connected with a purification and analyzing system for purifying and analysing characteristics of the products of gasification.

The biomass gasification system further comprises a plurality of injectors positioned along the length of the gasification reactor for injecting oxy-steam gasifying media inside the reactor. In one example, the plurality of injectors are radially protruded inside the reactor up to a certain depth for appropriately providing the flow distribution of oxy-steam mixture across the gasification reactor for improving the pyrolysis zone height and rate. In another possible implementation, the plurality of injectors protruded inside the reactor may bend downward towards the side walls of the reactor by an angle to efficiently provide the oxy-steam mixture across most difficult locations of the gasification reactor to reach for. In one example, the gasification reactor is divided in multiple circumferential layers each having plurality of injectors positioned azimuthally separated by different arc lengths/angles subtending at the centre. In an example, the number of injectors, concentration of oxy-steam mixture, and quantity of mixture transferrable from injectors in each circumferential layer may vary based on the position of the circumferential layer along the lengthwise extension of the gasification reactor.

The biomass gasification system may further includes a plurality of thermocouples coupled to the gasification reactor along the length of the gasification reactor. The gasification system may also contain plurality of thermo-couples distributed azimuthally and protruding to different depths of the reactor. The plurality of thermocouples are used to monitor the temperature profile inside the reactor for providing appropriate temperature reading during the operation of the gasification system to efficiently determine the requirement of the reactor. Based on the determined temperature profile, the temperature of the oxy-steam mixture and the ratio of oxygen to steam is adjusted to provide adequate amount of reactant and hence energy or heat for increasing the rate of pyrolysis. Further, the biomass gasification system includes an ignition nozzle close to the bottom end of the gasification reactor for igniting the char bed inside the reactor for initiating the gasification process.

The above aspects, and advantages of the subject matter will be better explained with regard to the following description, appended claims, and accompanying figures. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numerals are used throughout the drawings to reference like features and components.

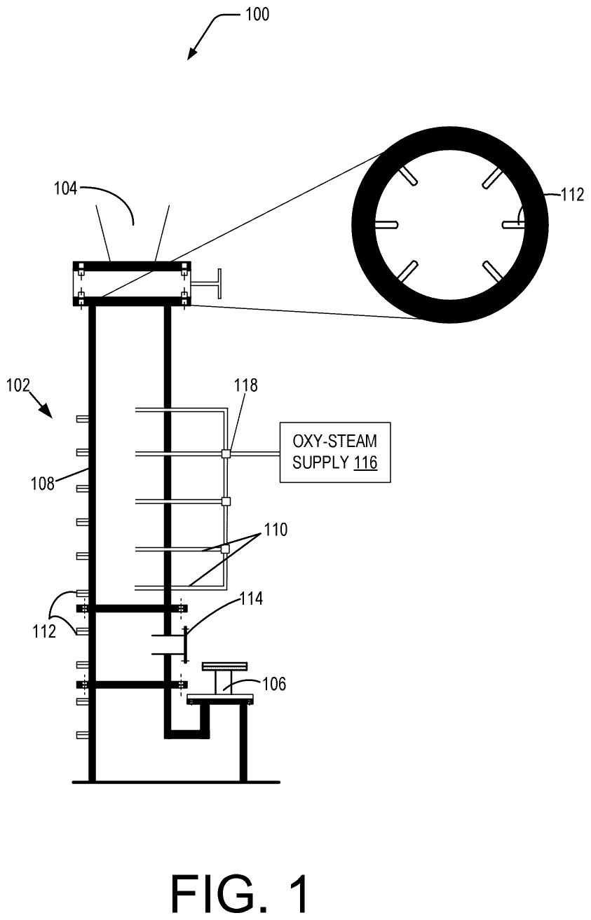

FIG. 1 depicts a front view of an example biomass gasification system 100 (referred to as the system 100). The system 100 is to gasify an inputted biomass feedstock (not shown in FIG. 1) in the presence of an oxy-steam mixture to provide a hydrogen rich syngas as an output product. To achieve this efficiently, the system 100 includes a gasification reactor 102 which is in simplest form is a cylindrical container receiving biomass from the top and discharging gas from the base. In an example, the gasification reactor 102 may further include an inlet 104 at a top end, an outlet 106 at a bottom end, and side walls 108 extending or disposed between the inlet 104 and the outlet 106.

In an example, the purpose of the inlet 104 of the gasification reactor 102 is to allow loading of the biomass feedstock inside the gasification reactor 102 and is provided with a lock hopper. The lock hopper, as may be understood, provides a means for continuously feeding the gasification reactor 102 to ensure a leakproof charging of biomass feedstock into the gasification reactor 102 by isolating it from ambient air surrounding. On the other hand, the outlet 106 of the gasification reactor 102 is for discharging a produced mixture of gases and is coupled with a purification and analysing system for purifying the mixture of gases to retrieve a required gas from the mixture of gases.

The system 100 further includes a plurality of injectors 110-1, 2, 3, . . . , N (referred to as injectors 110) positioned along the length of the gasification reactor 102. The injectors 110 are meant for injecting gasification agents, such as oxygen, steam, or oxy-steam mixture, inside the reactor for enabling combustion of gases and char (charcoal). In an example, as shown in the expanded top view of the gasification reactor 102 in FIG. 1, the injectors 110 are protruded radially inside the gasification reactor 102 up to a certain depth to maintain a proper flow distribution of the gasification agent across the gasification reactor 102.

In an example, the injectors 110 along the length of gasification reactor 102 are arranged in such a manner that the gasification reactor 102 is divided in multiple circumferential layers having certain width and each layer having certain number of injectors displaced and staggered circumferentially and azimuthally by an angle of deplacement from each other. For example, assuming the gasification reactor 102 to be divided into 3 layers from top end to the bottom end, 1^{st} circumferential layer may include 3 injectors with 120° separation from each other, 2^{nd} circumferential layer have same 120° separation between 3 of the injectors but these are displaced by an angle of 60° with respect to the injectors of the 1^{st} circumferential portion, and the 3^{rd} circumferential layer has 6 injectors having 60° separation each with certain displacement w.r.t to injectors of other layers. It may be noted that, the number of circumferential layer, number of injectors on each layer, and angle of separation between injectors of similar layer and other layers is exemplary and any other combination of these parameters may be used to get improved results without deviating from the scope of the present subject matter.

Further, the depth of insertion of the injectors 110 inside the gasification reactor 102 may vary with the maximum depth being the center of the gasification reactor 102 and minimum being the side walls 108. It may be noted that, the number of injectors 110, angle of separation between the injectors 110 and depth of injectors 110 inside the gasification reactor 102 in each circumferential layer may vary based on the position of the circumferential layer along the lengthwise extension of the gasification reactor 102. In another example, other features such as temperature profile and quantity of biomass inside the gasification reactor 102 may also effect the above disclosed features of injectors 110 in each circumferential layer without limiting the scope of the present subject matter. In another example, the diameter of opening of injectors 110 may vary to control the velocity of flow of gasification agent inside the gasification reactor 102.

The system 100 may further includes a plurality of thermocouples 112 coupled along the length of the gasification reactor 102. The plurality of thermocouples 112 are meant for measuring the temperature inside the reactor for determining a temperature profile of the reactor. As may be understood, that the temperature is the sole deciding factor for finding the amount of biomass disintegrates into char and gases because as high as the temperature inside the reactor reaches, more the biomass starts breaking into char and gases. So, for monitoring and for having a good look at the temperature variation, these plurality of thermocouples 112 help in analysing the temperature profile inside the reactor (the same will be discussed in upcoming figures). Further, the temperature readings of the plurality of thermocouples 112 may also be used for setting the temperature of injecting oxy-steam mixture to provide appropriate heat inside the reactor. The temperature readings may also be used to set the Oxygen-Steam ratio at particular injectors.

The system 100 may further include an ignition nozzle 114 located at the bottom of the gasification reactor 102 for igniting the biomass. In an example, the ignition nozzle 114 is located near to a char bed for igniting the bed for initiating the gasification process.

In an example, in operation, initially the charcoal is charged inside the gasification reactor 102 up to a combustion zone and the biomass feedstock is topped over that via inlet 104 up to a drying zone, and thereafter, the gasification reactor 102 is set into suction mode/negative pressure through the operation of the suction blower aided by the scrubbing nozzles (not shown in FIG. 1) and the char bed formed from the charcoal is ignited through ignition nozzle 114 using an external source of energy. Once the charcoal start burning, it produces heat, and the biomass starts drying at the top. The dried biomass then moves into a pyrolysis zone in which it gets pyrolyzed and further disintegrates into char and mixture of gases. Thereafter, based on the temperature readings of the plurality of thermocouples 112, the oxy-steam mixture is injected through the injectors 110 protruding inside the gasification reactor 102.

In an example, the injectors 110 are further coupled to an oxy-steam supply 116. Instead of oxy-steam supply 116, the injectors 110 may also be coupled to multiple sources supplying oxygen and steam separately without deviating from the scope of the invention. In an example implementation, the injectors 110 while coupling with the oxy-steam supply 116 may mid-way coupled with a plurality of junction elements 118. In an example, the junction elements 118 enables controlling concentration of gasification agent flowing inside the gasification reactor 102. Further, these junctions 118 may enable mixing of oxygen and steam, when coming from different supply sources. The opening and closing of the junction elements 118 may be controller by valves based on the requirement of oxygen and steam inside the reactor, wherein the same may be controller automatically or manually based on the temperature profile. Therefore, the steam concentration in the oxy-steam mixture is varied to control the SBR of the gasification reactor 102 somewhere between 2.0 to 3.5. For example, initially the oxy-steam mixture contains higher concentration of oxygen and once char (i.e. Carbon (C)) starts forming inside the gasification reactor 102, the oxy-steam mixture with higher steam concentration is being injected to increase rate of water gas reaction.

Thereafter, based on the available oxy-steam mixture, the pyrolyzed char and gases further combust to generate heat which in turn accelerates the pyrolysis as it is dependent on the temperature inside the gasification reactor 102. It may be noted, with higher steam concentration, the Steam to Biomass Ratio (SBR) starts increasing which results in higher char consumption because now steam started reacting with both char and CO to generate hydrogen. So, it may be noted that at higher SBR, the hydrogen yield is increased unprecedently and char consumption increases as well. To maintain a balance inside the gasification reactor 102 it is required to increase char generation as well. The same is accomplished by injecting oxy-steam mixture up to a certain depth as well as height inside the gasification reactor 102 at certain injecting temperature and higher Oxygen to Steam ratio with the help of injectors 110 for increasing the rate of combustion which eventually increases the rate of pyrolysis. In this way, the CBL of the system 100 is extended beyond the conventional limit by increasing char generation. The complete spectrum of results corresponding to the oxy-steam injection using the system 100 is presented in Table 3. It may be noted that, with an increase in the SBR, the hydrogen yield per kilogram of biomass increases and the same is monotonous with SBR. Further, with increasing SBR, the fraction of Hydrogen contributed from steam increases.

TABLE 3
Oxy-Steam gasification operation - consolidated results.

| | Within Carbon Boundary | | | | Beyond Carbon Boundary | | | |
|---|---|---|---|---|---|---|---|---|
| SBR | 0.75 | 1.00 | 1.40 | 1.50 | 1.80 | 2.50 | 2.70 | 3.5 |
| ER | 0.21 | 0.18 | 0.21 | 0.23 | 0.27 | 0.30 | 0.30 | 0.30 |
| H2 yield | 41.8 ± 0.8 | 45.2 ± 0.7 | 43.1 ± 0.8 | 45.2 ± 0.5 | 49.6 ± 1 | 51.7 ± 1.1 | 50.5 ± 0.7 | 52.5 ± 0.7 |
| vol % | | | | | | | | |
| H2 yield | 66 ± 2 | 68 ± 1 | 71 ± 2 | 73 ± 1 | 94 ± 2 | 99 ± 2 | 104 ± 2 | 110 ± 3 |
| (g kg − 1 of | | | | | | | | |
| biomass) | | | | | | | | |
| H2 yield | 21.4 | 20.2 | 28 | 27.7 | 43.7 | 44.3 | 48.1 | 50.1 |
| from steam | | | | | | | | |
| (%) | | | | | | | | |
| LHV | 8.9 ± 0.3 | 8.6 ± 0.4 | 8.8 ± 0.2 | 8.7 ± 0.2 | 7.8 ± 0.4 | 7.5 ± 0.5 | 7.4 ± 0.3 | 7.3 ± 0.6 |
| (MJ Nm − 3) | | | | | | | | |
| Energy | 80.3 ± 2 | 73.5 ± 1.5 | 76.3 ± 1 | 73.5 ± 1 | 77 ± 1 | 65.8 ± 1.5 | 65.6 ± 1 | 62.5 ± 1 |
| efficiency | | | | | | | | |
| (%) | | | | | | | | |

While pyrolysis is going on, the output hydrogen rich syngas is being collected from the outlet 106. In an example, the outlet 106 is connected to a purification and analysing system (not shown in FIG. 1) including a scrubber, a gas analyser, and a flow measuring device. In an example, the scrubber helps in separating particulates and moisture and helps in cooling the hydrogen-rich syngas. The gas analyser analyses and provides composition of the hydrogen rich syngas and the flow measuring device measures the flow of the hydrogen rich syngas. In an example, the outlet 106 of the gasification reactor 102 is further connected to a burner (not shown in FIG. 1). The burner may act as a target source for consuming the hydrogen rich syngas. It may be noted that, instead of burner, a different power generating engine may be used. These and other examples are explained in further detail in conjunction with the other figures.

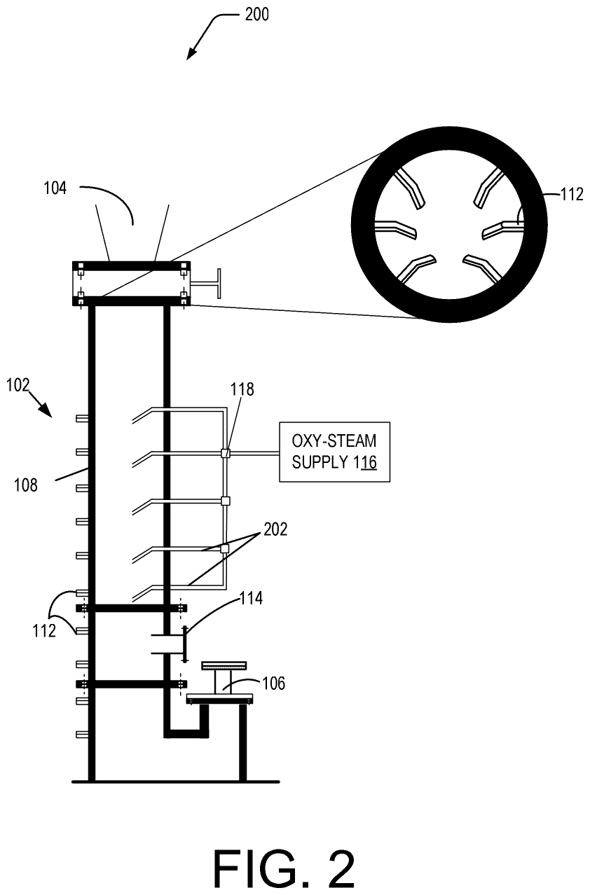

FIG. 2 depicts a front view of another example biomass gasification system 200 (referred to hereinafter as the system 200), similar to that of system 100. The system 200 includes a gasification reactor 102 including an inlet 104 with a lock hopper, an outlet 106, and side walls 108 disposed between the inlet 104 and the outlet 106. The system 200 may further include a plurality of injectors 202-1, 2, 3, . . . , N protruding inside the reactor up to a certain depth along the length of the gasification reactor 102. In an example, the injectors 202-1, 2, 3, . . . , N (referred to as injectors 202) are inclined at an angle with respect to the side walls 108 of the gasification reactor 102. The inclination angle between the injectors 202 and side walls 108 may vary with respect to the position of the injectors. It may be noted that, bending of injectors 202 towards the side walls 108 enable appropriate sprinkling or staged distribution of oxy-steam mixture on unreachable locations to enhance the combustion of the char and the gases. As a result of increased consumption, higher amount of heat is generated which in turn may help in increasing the rate of pyrolyzing the biomass for increasing the rate of generation of char and extends the CBR beyond its conventional limits.

In an example, as shown in the expanded top view of the gasification reactor 102 in FIG. 2, the injectors 202 are protruded radially inside the gasification reactor 102 having a portion inclined with the side walls 108 to a certain depth to maintain a proper flow distribution of the gasification agent across the gasification reactor 102.

The system 200 may further include other components like thermocouples 112, ignition nozzle 114, oxy-steam supply 116, junctions 118, a scrubber, a gas analyser, a flow measuring device, and a burner similar to that of system 100.

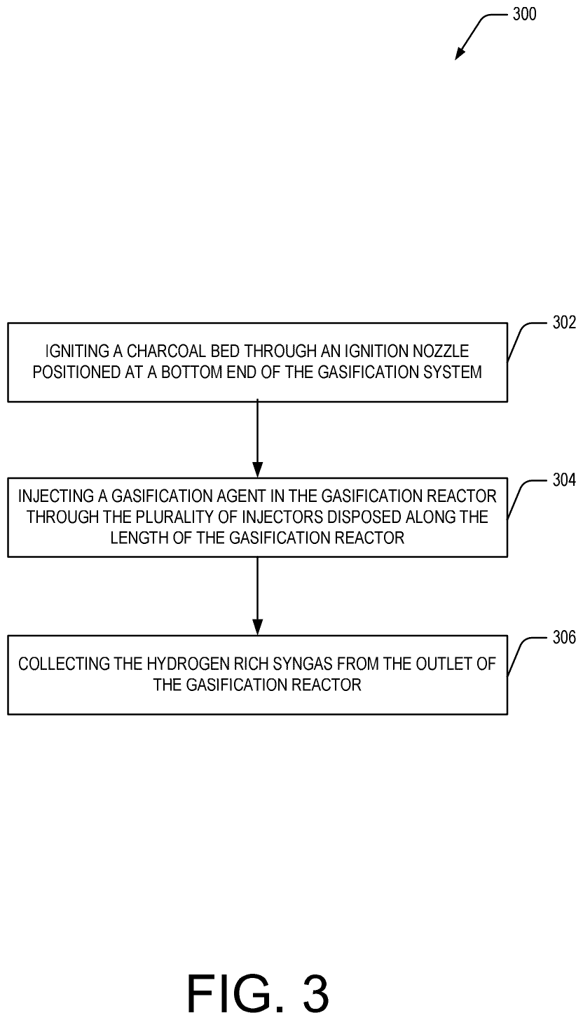

FIG. 3 illustrates a process for converting a biomass feedstock into a hydrogen rich syngas, as per an example. Although process 300 may be implemented in a variety of biomass gasification system, for ease of explanation, the present description of the example process 300 is provided in reference to the above-described system 100 and 200 (collectively referred to as systems 100, 200).

The order in which the process 300 is described is not intended to be construed as a limitation, and any number of the described process blocks may combine in any order to implement the process 300, or an alternative process. It may be understood that the blocks of the process 300 may be implemented on any one of the systems 100, 200.

At block 302, a charcoal bed formed by loading charcoal is ignited through an ignition nozzle 114. For example, the ignition nozzle 114 present at a bottom end of the systems 100, 200 is used for igniting charcoal bed to provide initial startup to the gasification process. In an example, the ignition is performed using an external source of energy. In an example, initially, charcoal and a biomass feedstock are loaded inside the systems 100, 200. The charcoal is loaded up to a level of combustion zone to form the charcoal bed and the biomass feedstock is topped or loaded above the charcoal bed up to a drying zone. For example, the inlet 104 of the gasification reactor 102 is used to charge the gasification reactor 102. Examples of biomass feedstock include, but may not be limited to, forest slash, urban wood waste, lumber waste, wood chips, sawdust, straw, firewood, agricultural residue, and the like.

Once the char bed is ignited, it starts generating heat which in turn dries the up stocked biomass feedstock. Thereafter, the biomass feedstock undergoes pyrolysis and disintegrates into char and mixture of gases.

At block 304, a gasification agent is injected inside the gasification reactor through the plurality of injectors disposed circumferentially around the gasification reactor and along the lengthwise extension of the side walls of the gasification reactor and inserted at a certain depth inside the gasification reactor. For example, in case of system 100, the gasification agent is injected through the injectors 110 which are protruding radially inside the gasification reactor 102 for appropriately introducing the oxy-steam mixture over the char bed to increase the char generation and char consumption at the same time. While the gasification agent may also be injected inside the reactor through injectors 202 of the system 200 which are inclined at a certain angle with the side walls 108 of the gasification reactor 102.

In an example, the temperature, concentration ratio, and quantity of the gasification agent is varied based on the temperature readings of the thermocouples 112 or based on the requirement of hydrogen. For example, as the temperature inside the reactor increases, more biomass starts breaking which results in increase in the rate of generation of char, resulting in extended CBR. Now, the generated char may react with oxy-steam mixture according to reaction R2 and R9 to form hydrogen. In this way, CBR of the reactor is extended and the steam to biomass ratio is extended beyond its limit to increase the yield of the hydrogen. Further, it may be noted that, higher the SBR, more concentration of H₂O is present and may react with CO to generate higher yield of H₂. Hereinafter, all the thermochemical reaction may take place automatically inside the gasification reactor 102 to make it self sustaining over a period of time.

At block 306, a hydrogen-rich syngas is collected from the outlet 106 of the gasification reactor 102. For example, outlet 106 of the gasification reactor 102 is used to retrieve the generated hydrogen-rich syngas. In an example, the outlet 106 of the gasification reactor 102 is coupled with purification and analyzing system (not shown in FIG. 1 and FIG. 2) for purifying the gases and analyzing the properties or characteristics of the syngas. The purification and analyzing system include the scrubber for separating particulates and moisture from the syngas and also helps in cooling of the hydrogen-rich syngas. The purification system may further include the gas analyzer and a flow measuring device for analyzing the composition of the hydrogen-rich syngas and measuring the flow of the hydrogen-rich syngas, respectively.

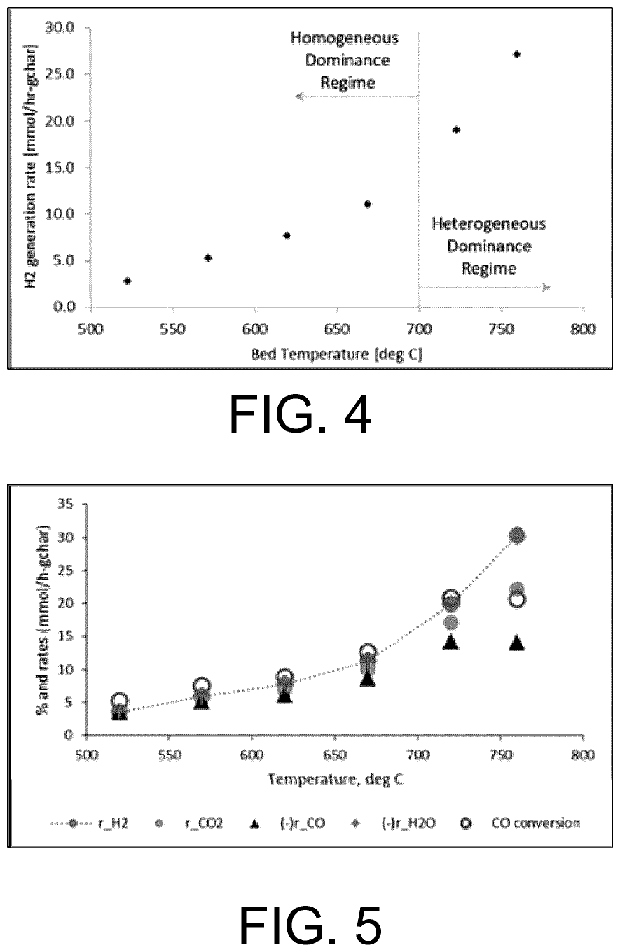

The following section is directed to provide various exemplary experimental results from FIGS. 4 to 14 for evaluating the char consumption rate in a fixed bed at different SBR, and temperature and evaluating the increase in the char generation rate due to proposed geometrical and procedural changes of the present subject matter. Although certain methods and compositions have been described herein as examples, the scope of coverage of this patent application is not limited thereto. On the contrary, the present subject matter covers all methods and compositions fairly falling within the scope of the claims either literally or under the doctrine of equivalents.

FIG. 4 presents a graph depicting variation of the hydrogen generation rate in response to change in bed temperature of the gasification system, in accordance with an implementation of the present subject matter. As explained earlier, there are multiple thermochemical reactions occur inside the reactor (depicted in Table 1) in which two reactions which are responsible for generation of hydrogen are R2 and R9. The reaction between CO and H₂O, i.e., reaction R9 is called as homogeneous reaction and the reaction between C and H₂O, i.e., reaction R2 is called as heterogeneous reaction. It is important to note from graph of FIG. 4 is that, with increase in bed temperature, the H₂ generation rate increases exponentially. Further, the graph suggests that up to about 700° C., homogeneous reaction, remains prominent. While beyond 700° C., the contribution of heterogeneous reaction involving char consumption also becomes prominent. So, by increasing bed temperature beyond a particular temperature, in this case 700° C., the hydrogen generation rate increases exponentially. As per the implementation of the present subject matter, this change in the bed temperature may be accomplished by injecting oxy-steam mixture with certain temperature.

FIG. 5 presents a graph depicting variation in the generation rate of various substance present inside the reactor in response to change in bed temperature of the gasification system, in accordance with an implementation of the present subject matter. In FIG. 5, legends r_ indicates the rate of change of a particular substance with (+) sign in front of the substance indicating production of the substance and (−) sign indicating consumption of the substance. The observation explained in the previous figure that on increasing bed temperature, especially beyond 700° C., hydrogen generation rate increases exponentially, and this is happen due to the prominence of the heterogeneous reaction is further supported by graph disclosed in FIG. 5. It is important to note from FIG. 5 that the H₂ generation rate remains slightly lower than the CO consumption rate up to about 700° C. but beyond this temperature, the H2 generation rate significantly increases as compared to the CO consumption rate. This gap between the two curves reinstate that, up to 700° C., the reaction between the CO and H₂O generates the hydrogen which lead to consumption of CO. However, beyond 700° C., the reaction between C and H₂O is more prominent, resulting in formation of additional CO which further reacts with H2O to generate additional H2.

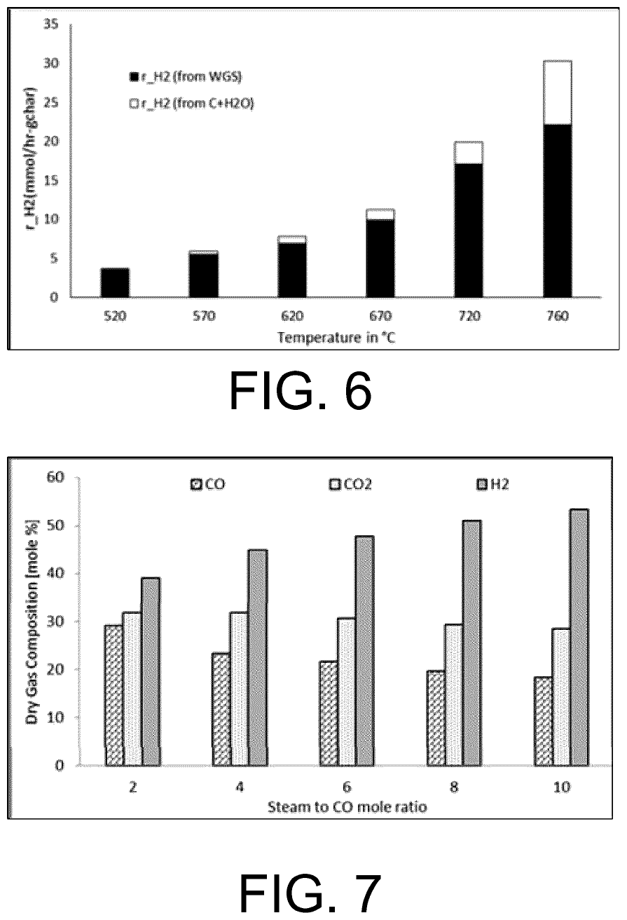

The above explained fact may be more clearly and explicitly established by comparing the magnitudes of contribution of respective reaction in generation of hydrogen. FIG. 6 presents a graph depicting variation of the hydrogen generation rate in response to change in bed temperature, in accordance with an implementation of the present subject matter. It is clearly evident from FIG. 6 that beyond 700° C., heterogenous reaction, i.e., C+H₂O starts to contribute significantly. Therefore, the contribution of char in generation of hydrogen is clearly more beyond 700° C. Since, it is established that char reaction becomes more critical beyond 700° C. Now, the next control experiments involve subjecting the char bed to gas mixture with varying SBR, where the bed temperature is maintained at 750+10° C.

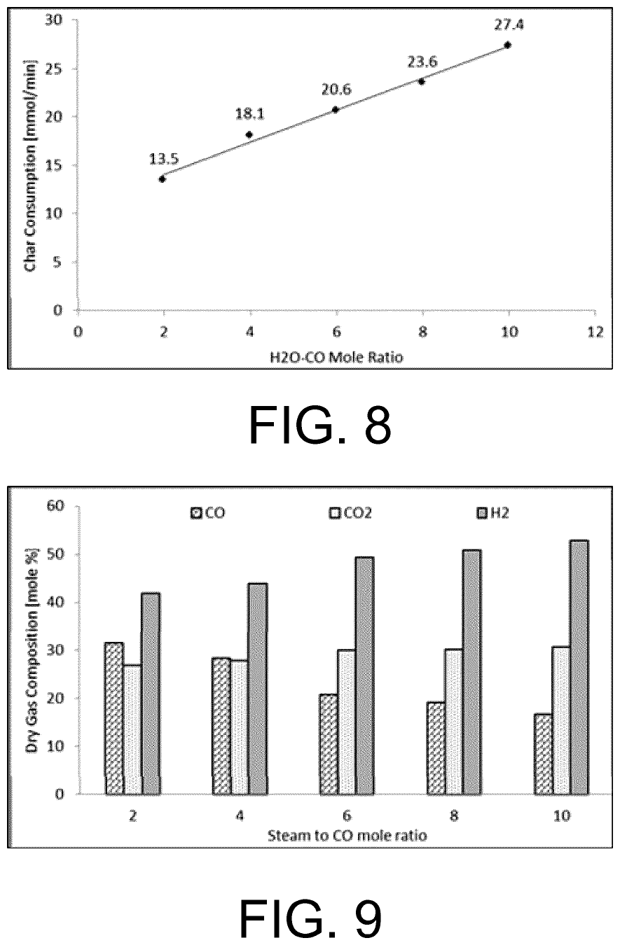

FIG. 7 presents a graph depicting variation in the composition of dry gases in response to change in steam concentration in the injecting mixture, in accordance with an implementation of the present subject matter. As explained earlier, the hydrogen generation reaction, i.e., R2 and R9 (in Table 1) involve H₂O as the major component. So, by increasing steam concentration in oxy-steam mixture, i.e., by increasing SBR, more hydrogen is generated. This vary fact may be supported by results presented in FIG. 7. It may be noted that, on increasing Steam concentration step by step from 2 to 10, H₂ concentration starts increasing and concentration of CO and CO₂ starts depleting which show that with increasing steam fraction, H₂O is not only reduced by char but also by CO to generate H2. FIG. 7 indicates that at the selected temperature range and at higher steam fractions, the char bed tends to act like a catalyst, promoting reaction of CO with H₂O apart from the sacrificial heterogeneous response. As a result, by appropriately tuning the moisture fraction (high SBR) and the operating temperature (beyond 700° C.), the char bed may act as a water gas shift reactor with higher hydrogen yield. The above-disclosed fact regarding increase in consumption of char with higher SBR may also be supported by graph depicted in FIG. 8.

FIG. 8 presents a graph depicting variation in char consumption in response to change in steam concentration in the injection mixture, in accordance with an implementation of the present subject matter. It is clearly evident from graph depicted in FIG. 8 that there is a near linear relationship between steam concentration and char consumption, i.e., on increasing steam fraction (increasing SBR), char consumption increases linearly. Now, it established that on higher temperature beyond 700° C. with higher SBR, the reduction of H₂O is performed by CO in the presence of char through homogeneous reactions (performed due to higher SBR) and by char through heterogeneous reactions (due to higher bed temperature).

FIG. 9 presents a graph depicting variation in the composition of dry gases in response to change in steam concentration in the injecting mixture in presence of CO₂ in the feed gas, in accordance with an implementation of the present subject matter. FIG. 9 extends the analysis to understand the implication of the presence of CO₂ in the feed gas, i.e., the char bed experiences a gas containing both CO₂ and CO. It may be noted that the presence of CO₂ shifts the chemical equilibrium of the system towards reactants by inhibiting particularly the gas-phase reaction. In order to understand the implication of the presence of CO₂, the char bed is subjected to a gaseous mixture (CO 20%; H₂ 20%; CH₄ 2%; CO₂ 12% and N₂ 46%) with the SBR controlled in such a way that steam concentration is varied from 2 to 10 in steps of 2. While in the case of pure CO-steam parametric analysis, the CO₂ concentration monotonously decreases with increase steam fraction (R). However, in the case of PG-steam parametric analysis, the CO₂ concentration increases with a steam fraction (R).

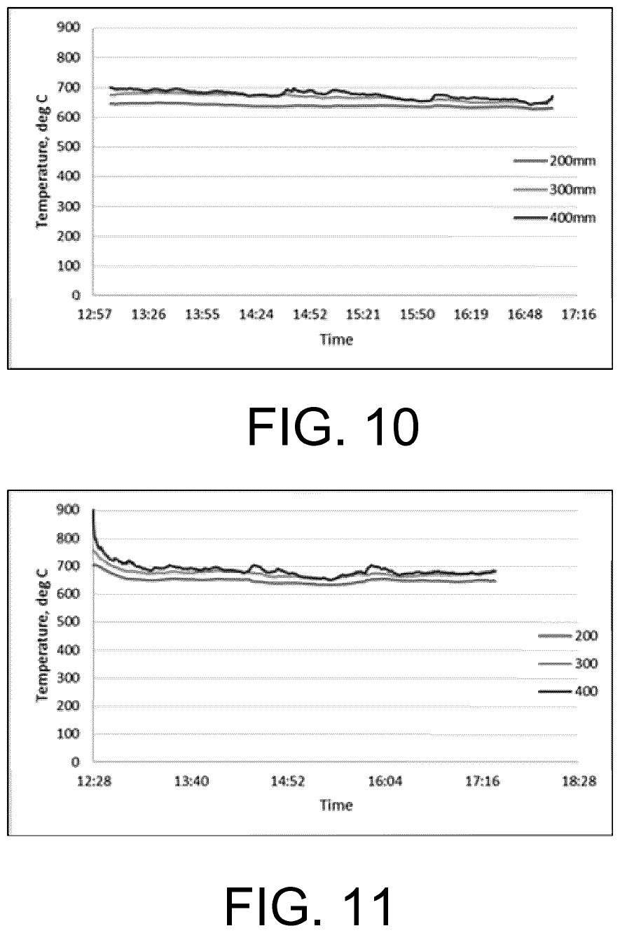

From above discussion, it is observed that, the system operating at a higher steam fraction provides a distinct advantage in terms of the char bed promoting the water gas shift reaction and also acting as a reducing agent of H₂O considering the same is performed at a temperature over 700° C. In order to determine if the current SBR concentration and injection temperature are enough to sustain the gasification process inside the gasification reactor 102, the temperature in the vicinity of the char zone is monitored carefully to determine a perfect combination between the injection temperature and SBR concentration which is explained in detail in conjunction with FIG. 10 to FIG. 13.

FIG. 10 presents a graph depicting variation of bed temperature in the vicinity of the char zone with changing time, provided SBR at 4.5 and injecting temperature at 500° C., in accordance with an implementation of the present subject matter. As explained earlier, carbon boundary is the point at which the char generation rate and consumption rate exactly match with each other, on exceeding which there is no excess char available in the bed. As described in conjunction with FIGS. 7 to 9, to increase the yield of hydrogen the SBR has to be increased, to increase the char consumption rate. However, in the course of operation at higher SBR, exceeding the carbon boundary point results in system instability. Typically, if the gasifier is operating beyond the Carbon boundary, the char consumption rate exceeds char generation rate which in turn deplete the char bed and partially pyrolyzed biomass starts to occupy the convention char zone. In such circumstance, the temperature in the vicinity of the char zone is reduced continuously which indicates that instability has set in. The temperature profile as depicted by FIG. 10 describes change in temperature in the vicinity of the char bed with SBR at 4.5 and T (injection temperature) at 500° C. indicating that char bed is depleting and any further operation would result in the deteriorating gas quality and finally in the termination of the gasification process itself. For example, reviewing the temperature profile in FIG. 10, it can be noticed that as the time progresses, the temperature continuously is going down, particularly in the vicinity of the ignition nozzle. This is a clear indication of depletion of the bed. Further, with the overall temperature being much lower than 700° C., the regime is not very conducive for Char conversion. It is worth to not that, such a low temperature in the char zone is not favorable for increasing char generation rate, as char generation is totally dependent on pyrolysis and it is basically an endothermic temperature-dependent process with direct temperature dependence.

FIG. 11 presents a graph depicting variation of bed temperature in the vicinity of the char zone with changing time, provided SBR at 3.4 and injecting temperature at 500° C. As depicted in graph of FIG. 11, while the temperature has now kind of stabilized, the temperature profile is still under 700° C. which is not favorable for increasing char generation rate to maintain the system in the carbon boundary limit. At this condition, the char generation is just about matching the char consumption, depicting operation in the vicinity of carbon boundary. It may be noted that, results in FIG. 10 and FIG. 11 clearly establish the fact that Char generating rate in the pyrolysis zone becomes the primary factor. Because, if char generation rate may be controller or enhanced, then operating the gasifier at higher SBR becomes possible to realize concurrent H₂ generation through homogeneous and heterogeneous reactions. So, increasing the temperature basically enhances the rate of pyrolysis and hence the char production rate.

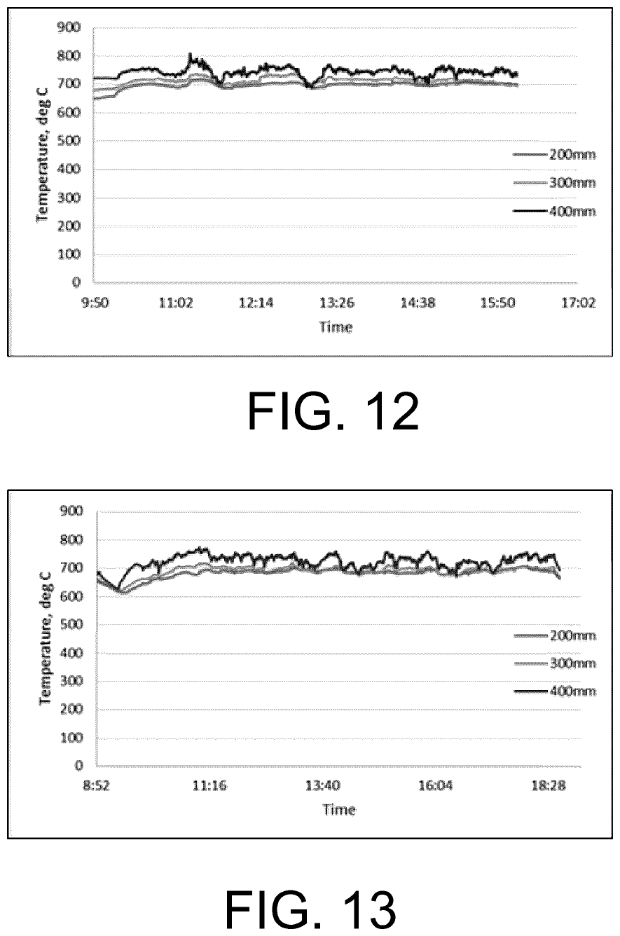

FIG. 12 presents a graph depicting variation of bed temperature in the vicinity of the char zone with changing time, provided SBR at 3.4 and injecting temperature at 600° C., as an example. In the present case, temperature in the vicinity of char zone is considered as a control parameter to control the rate of pyrolysis and char generation. So, the oxy-steam mixture injection temperature was increased to values higher than 500° C. The temperature profile as depicted by FIG. 12 describes change in temperature in the vicinity of the char bed with SBR at 3.4 and T (injection temperature) at 600° C. indicates that bed temperature broadly remains above the 700° C. without any hint of reduction over time. However, the intermittent drops are characteristics of ash extraction and not a general bed profile disturbance. This is the condition wherein the char generation is slightly over the thermo-chemical char consumption and positive extraction of Char is carried out through the extraction screw.

Now, the mixture injection temperature is further increased to 727° C. while reducing the SBR from 3.4 to 2.9 which is presented in FIG. 13. The temperature profile depicted in FIG. 13 clearly and explicitly shows that the bed temperature profile holds without any temperature drop over a period of close to 10 hours. It may be noted that, the results in FIG. 12 and FIG. 13 specifically indicate that on increasing the mixture injection temperature, the Carbon Boundary's SBR has been extended well beyond 1.5.

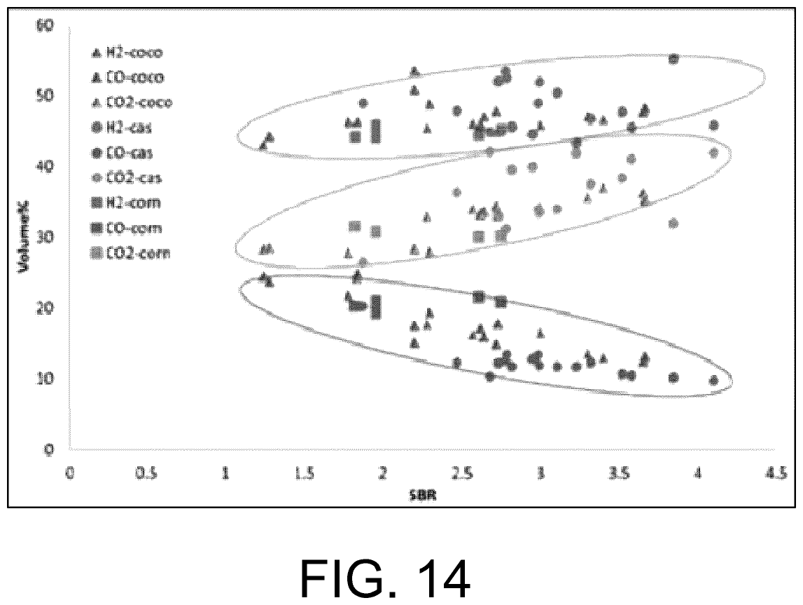

FIG. 14 presents a graph depicting variation in the composition of dry gases in response to change in steam concentration (increasing SBR) for different biomasses as a feedstock, in accordance with an implementation of the present subject matter. Example of biomass feedstock used by performing the experiment include sized coconut shells, casuarina chips, and corn cobs. The experiment is performed by subjecting the biomass feedstock to oxy-steam gasification over a range of SBR with the oxy-steam mixture temperature maintained at over 700° C., in order to facilitate faster pyrolysis and hence faster char formation. The properties of feed types is represented in below Table 4. The gasification system is not restricted to feedstock presented in table 4 and is only a broad representation of the biomass types tested.

TABLE 4
Properties of feed types used for gasification

| Fuel type | Wood chips | Coconut shells | Corn cobs |
|---|---|---|---|
| Fuel Dimension (mm) | 24 × 25 × 40 mm | 4 × 25 × 40 mm | 25 × 30 × 40 mm |
| Density (kg/m³) | 650 ± 10 | 1100 ± 100 | 400 |
| Bulk density (kg/m³) | 400 | (400-450) | 159 ± 6 |
| Moisture content (%) | 11 | 8 | 10 |
| Ash content (%) | <3 | <1.5 | <4 |

Based on the graph depicted in FIG. 14, the H2 fraction increases with an increase in SBR with a concurrent reduction in CO. So, the present graph confirms that by increasing the injection temperature and SBR, the production of H₂ increases and the carbon boundary of the gasifier is also extended beyond its conventional limits to make the system operational for a longer period of time. The performance parameters corresponding to gasification with Casuarina wood chips are presented in Table 5 below. It is important to note that similar results have also been observed for different types of biomass. However, for brevity, only the results of Casuarina wood chips are presented.

TABLE 5
Performance of Oxy-steam gasification system
with Casuarina over a range of SBR

| SBR | 1.80 | 2.50 | 2.70 | 3.5 |
|---|---|---|---|---|
| ER | 0.27 | 0.30 | 0.30 | 0.30 |
| H2 yield | 49.6 ± 1 | 51.7 ± 1.1 | 50.5 ± 0.7 | 52.5 ± 0.7 |
| vol % | | | | |
| H2 yield | 94 ± 2 | 99 ± 2 | 104 ± 2 | 110 ± 3 |
| (g kg −1 of biomass) | | | | |
| H2 yield from steam (%) | 43.7 | 44.3 | 48.1 | 50.1 |
| LHV | 7.8 ± 0.4 | 7.5 ± 0.5 | 7.4 ± 0.3 | 7.3 ± 0.6 |
| (MJ Nm−3) | | | | |
| Energy efficiency | 77 ± 1 | 65.8 ± 1.5 | 65.6 ± 1 | 62.5 ± 1 |
| (%) | | | | |

On analyzing performance parameters represented in table 5, it may be observed that the highest hydrogen yield per kilogram of biomass reported at the carbon boundary of SBR 1.5 with yield being 73 g/Kg at energy efficiency of 73.5% is increased to 110 g/Kg of biomass at SBR 3 and SBR energy efficiency of 62.5%. Further, in H₂ yield, the contribution of steam has increased from 28% to 45%. Overall, by controlling mixture injection temperature, a control over the Carbon Boundary SBR has been realized which in turn permits stable operation of the system at higher SBR and providing a higher H₂ yield for per kilogram of biomass due to activation of both homogeneous and heterogeneous reactions.

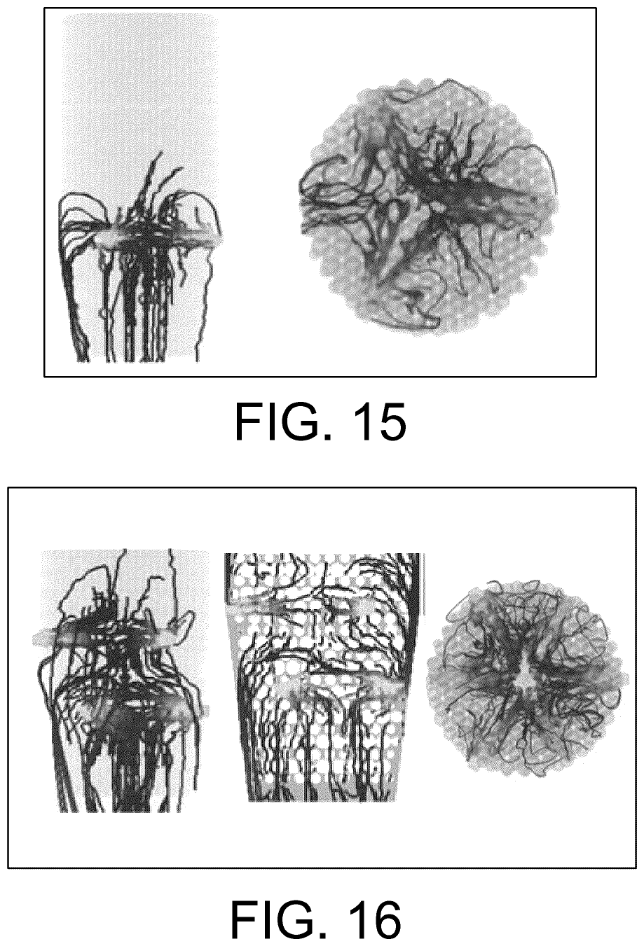

FIG. 15-16 depicts flow simulation of injecting mixture for respective configuration of injectors along the gasification reactor 102 of the gasification system, in accordance with an implementation of the present subject matter. As explained earlier, for increasing hydrogen yield from biomass gasification, the gasification systems need to maintain uniform thermo-physical conditions across reactor to ensure stable operation of the gasifier. One of the ways to achieve this is by extending the Carbon boundary of the reactor with smooth variation of SBR and setting a reactor temperature for increasing the rate of char consumption which in turn upgrades the output of the reactor. However, to ensure such outcome, the rate of pyrolysis and char generation should be matched with the consumption of the char. To this end, multiple injection configurations are established to maximize the pyrolysis zone height and the rate of the pyrolysis. Some of the examples of exemplary configuration include, staggering the oxy-steam mixture injectors along the axis of the reactor and distributed azimuthally at each axial plane, providing certain varying angle to the mixture injection points protruding into the reactor, and precise control over the steam-oxygen ratio at each injection point.

FIG. 15 represents the simplest flow configuration involving gasification media inlet through three radial entry points azimuthally displaced by 120° C. It is clearly evident from the flow simulation that the gasifying media above the inlets is extremely limited and also beneath the injection point, wherein the reach of the gasification media is not satisfying much for improving pyrolysis zone height and pyrolysis rate. There are many configurations possible for catering to the need of the gasification system, one of the configurations is presented in FIG. 16. FIG. 16 shows that the gasification reactor 102 is divided in multiple circumferential layers having certain width including plurality of injectors staggered azimuthally, with the injectors are protruded radially inside the reactor or protruded with a bend with respect to the side walls 108 of the gasification reactor 102. As depicted in flow simulation of FIG. 16, the proposed injection configuration ensures distribution of gasifying media across the length and width of the gasification reactor 102 and thereby help in enhancing pyrolysis zone height and the rate of pyrolysis.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

I/We claim:

1. A biomass gasification system (100) comprising:
a gasification reactor (102) configured to gasify a biomass feedstock into a hydrogen rich syngas, wherein the gasification reactor (102) comprises an inlet (104) at a top end, an outlet (106) at a bottom end, and side walls (108) disposed between the inlet (104) and the outlet (106);
a plurality of injectors (110) protruding radially up to a depth inside the gasification reactor (102) for injecting a gasification agent, wherein the plurality of injectors (110) are positioned circumferentially around the gasification reactor (102) and along the lengthwise extension of the side walls (108) of the gasification reactor (102);
a plurality of thermocouples (112) coupled to the gasification reactor (102) along the length of the gasification reactor (102) for measuring temperature; and
an ignition nozzle (114) located at the bottom end of the gasification reactor (102) for igniting the biomass feedstock.

2. The biomass gasification system (100) as claimed in claim 1, wherein the biomass, such as wood chips, coconut shells, corn cobs, agro residue pellets, are charged through the inlet (104) coupled to a lock-hopper and the hydrogen rich syngas is recovered from the outlet (106) coupled to a purification and analysing system, wherein the purification and analysing system comprises a scrubber, a gas analyzer, and a flow measuring device.

3. The biomass gasification system (100) as claimed in claim 1, wherein the plurality of injectors (110) are configured to inject gasification agents such as oxygen, system, or oxy-steam mixture inside the gasification reactor (102) at certain temperature and concentration based on the temperature profile sensed by the plurality of thermocouples (112) coming from a oxy-steam supply (116).

4. The biomass gasification system (100) as claimed in claim 1, wherein the temperature of injected gasification agents is ranged from 500 to 750° C. for increasing the rate of pyrolysis and for enabling heterogenous char reaction.

5. The biomass gasification system (100) as claimed in claim 1, wherein the gasification reactor (102) is divided in multiple circumferential layers each having plurality of injectors (110) positioned azimuthally displaced by a certain angle, wherein the number of injectors (110) in each circumferential layer depends on the position of the circumferential layer along the lengthwise extension of the gasification reactor (102).

6. The biomass gasification system (100) as claimed in claim 6, wherein the depth of the plurality of injectors (110) in each circumferential layer inside the gasification reactor (102) depends on the position of the circumferential layer along the lengthwise extension of the gasification reactor (102).

7. A biomass gasification system (200) comprising:
a gasification reactor (102) comprising an inlet (104), an outlet (106) and side walls (108) configured to gasify a biomass feedstock into a hydrogen rich syngas gas;
a plurality of injectors (202) protruding inside the gasification reactor (102), wherein the plurality of injectors (102) are inclined at an angle with respect to the side walls (108), wherein the plurality of injectors (202) are positioned circumferentially around the gasification reactor (102) and along the lengthwise extension of the side walls of the gasification reactor (102);
a plurality of thermocouples (112) coupled along the length of the gasification reactor (102) to monitor the temperature of the gasification reactor (102); and
an ignition nozzle (114) located at a bottom end of the gasification reactor (102) for igniting the biomass feedstock.

8. The biomass gasification system (200) as claimed in claim 7, wherein the injecting temperature, concentration ratio of gasification agent and the quantity of the gasification agent is controlled based on the temperature inputs from the plurality of thermocouples (112).

9. The biomass gasification system (200) as claimed in claim 7, wherein the gasification reactor (102) is divided in multiple circumferential layers with each layers comprising plurality of injectors (202) positioned azimuthally with displacement by a certain angle for staggering the oxy-steam mixture across the gasification reactor (102), wherein the number of injectors (202) in each circumferential layer depends on the positioning of the circumferential layer along the lengthwise extension of the gasification reactor (102).

10. The biomass gasification system (200) as claimed in claim 7, wherein the depth of the plurality of injectors (202) in each circumferential layer inside the gasification reactor (102) depends on the position of the circumferential layer along the lengthwise extension of the gasification reactor (102).

11. The biomass gasification system (200) as claimed in claim 7, wherein the outlet (106) of the gasification reactor (102) is coupled with a purification and analyzing system comprising a scrubber, a gas analyzer, and a flow measurement unit.

12. A method (300) for converting a biomass feedstock into a hydrogen rich syngas using a biomass gasification system (100, 200), wherein the method (300) comprises:
igniting (302) a charcoal bed through an ignition nozzle (114) positioned at a bottom end of the biomass gasification system (100, 200), wherein the biomass gasification system (100) comprises:
a gasification reactor (102) comprising an inlet (104), an outlet (106), and side walls (108) configured to gasify the biomass feedstock into a hydrogen rich syngas;
a plurality of injectors (110, 202) positioned circumferentially around the gasification reactor (102) and along the lengthwise extension of the side walls (108) of the gasification reactor (102), wherein a first set of injectors (110) from the plurality of injectors are protruding radially inside the gasification reactor (102) and a second set of injectors (202) are inclined at an angle with respect to the side walls (108);
injecting (304) a gasification agent in the gasification reactor (102) through the plurality of injectors (110, 202) disposed along the length of the gasification reactor (102); and
collecting (306) the hydrogen rich syngas from the outlet (106) of the gasification reactor (102), wherein the steam to biomass ratio is varied in a range of 2.7 to 3.5 for increasing the yield of hydrogen.

13. The method (300) as claimed in claim 12, wherein the method further comprises:
controlling concentration of steam in oxy-steam mixture, temperature and quantity of oxy-steam mixture injecting inside the gasification reactor (102) based on the temperature profile of the gasification reactor (102) sensed by the plurality of thermocouples (112).

14. The method (300) as claimed in claim 11, wherein the method further comprises:
loading charcoal up to a combustion zone to form a charcoal bed and a biomass feedstock above charcoal up to a drying zone in a gasification reactor (102).

15. The method (300) as claimed in claim 13, wherein the temperature of injected gasification agents is ranged from 500 to 750° C. for increasing the rate of pyrolysis and to enable heterogeneous char reaction.
